(19) United States
(12) Patent Application Publication
(10) Pub. No.: US 2017/0061059 A1
(43) Pub. Date: Mar. 2, 2017

(54) TIMING WINDOW MANIPULATION FOR NOISE REDUCTION

(71) Applicant: International Business Machines Corporation, Armonk, NY (US)

(72) Inventors: JAMES C. GREGERSON, HYDE PARK, NY (US); KERIM KALAFALA, RHINEBECK, NY (US); TSZ-MEI KO, POUGHKEEPSIE, NY (US); GREGORY M. SCHAEFFER, POUGHKEEPSIE, NY (US)

(21) Appl. No.: 14/836,416

(22) Filed: Aug. 26, 2015

(51) Int. Cl. G06F 17/50

(52) U.S. Cl. CPC G06F 17/5081; G06F 17/5077

(57) ABSTRACT

Timing window manipulation for noise reduction includes: selecting a path of a circuit design having a timing violation from a timing analysis of a victim window; determining an aggressor net coupled to a victim net along the path; determining a propagation path through the determined aggressor net; propagating a victim window value backward through the propagation path, the victim window value associated with the victim net; and modifying circuit characteristics of the circuit design within a switching window associated with the aggressor net based at least on the propagated victim window value.

### BACKGROUND

The present disclosure is generally related to data processing, or, more specifically, methods, apparatus, and products for timing window manipulation for noise production.

### DESCRIPTION OF RELATED ART

As the complexity of modern electronic devices increases, so too does the complexity of the design tools used in creating those devices. For example, timing design tools face increasing challenges in optimization. Path delays are increasingly constrained with increasing clock frequency, power budgets are increasingly constrained with increasing gate and wire density, and there is an increasing effect on delay from coupling noise with decreasing proximity between wires. In order to address these issues, it becomes increasingly important to achieve timing closure when considering coupled noise impact without significantly increasing power.

### SUMMARY

Methods, apparatus, and products for timing window manipulation for noise reduction are disclosed in this specification. Such timing window manipulation includes: selecting a path of a circuit design having a timing violation from a timing analysis of a victim window; determining an aggressor net coupled to a victim net along the path; determining a propagation path through the determined aggressor net; propagating a victim window value backward through the propagation path, the victim window value associated with the victim net; and modifying circuit characteristics of the circuit design within a switching window associated with the aggressor net based at least on the propagated victim window value.

The foregoing and other objects, features and advantages described herein will be apparent from the following more particular descriptions of example embodiments as illustrated in the accompanying drawings wherein like reference numbers generally represent like parts of example embodiments.

### BRIEF DESCRIPTION OF THE DRAWINGS

FIG. 1 sets forth a block diagram of automated computing machinery comprising an exemplary computer useful in timing window manipulation for noise reduction according to embodiments of the present disclosure.

FIG. 2 sets forth a flow chart illustrating an exemplary method for timing window manipulation for noise reduction according to certain embodiments of the present disclosure.

FIG. 3 illustrates an example victim window diagram for manipulating timing windows for noise reduction, in accordance with certain embodiments of the present disclosure.

FIG. 4 illustrates an example timing graph illustrating a result of modifying circuit characteristics of the circuit design within a switching window associated with the aggressor net, in accordance with certain embodiments of the present disclosure.

### DETAILED DESCRIPTION OF EXAMPLE EMBODIMENTS

Modeling electronic devices often includes a timing analysis of that model. As electronic devices increase in complexity, so too does the associated timing analysis. Various constraints determine whether a particular design may achieve timing closure (e.g., whether the device meets design timing requirements). Of particular concern are increased effects due to the increasing density of device components. As components move closer together, the opportunities for one component to induce noise in another component (e.g., through a coupling capacitance) correspondingly increase.

Components of an electronic device may have different switching “windows,” or periods of time in which the component may switch from one state to another. When the switching windows of components overlap, any induced noise may have a deleterious effect on the component with the induced noise. This effect may result in errors in the timing of the affected component, as well as further timing effects downstream from the affected component. Certain known techniques for addressing these errors face a number of limitations including a focus only on the affected component, a reliance on increased power to address errors, failure (or inadequacy) to account for downstream effects, and the like.

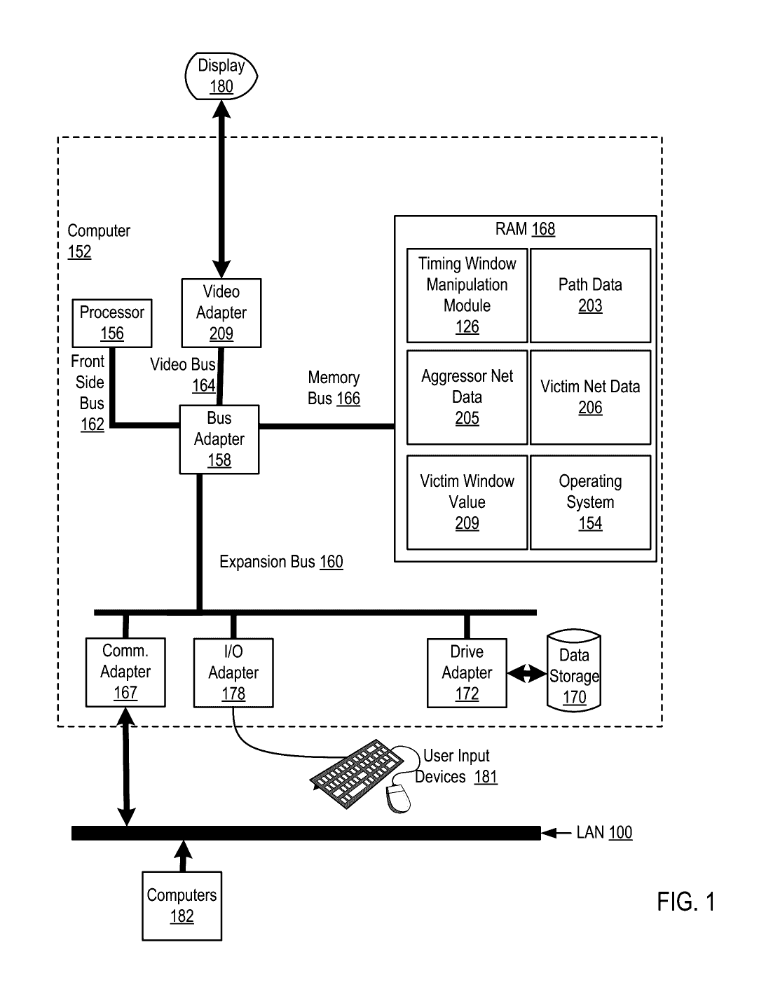

By contrast, timing window manipulation for noise reduction, according to embodiments described herein, may reduce power consumption while addressing downstream effects after a local change. Manipulating timing windows for noise reduction is generally implemented with computers, that is, with automated computing machinery. FIG. 1 sets forth a block diagram of automated computing machinery comprising an exemplary computer (152) useful in timing window manipulation for noise reduction according to embodiments described herein. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a timing window manipulation module (126), a module of computer program instructions for timing window manipulation for noise reduction, as described in more detail below. The timing window manipulation module (126) may manipulate one or more timing window(s) to reduce noise by first selecting a path (203) with a timing violation from a timing analysis of a victim window, selecting a path (203) with a timing violation from a timing analysis of a victim window may include receiving a path identifier, one or more timing violation identifiers, and other relevant timing analysis data such as node identifiers, arrival time levels at various nodes along the path, and the like. Although only a single path, a single victim net, a single aggressor net, and so is referenced here, readers of skill in the art will recognize that timing window manipulation for noise reduction may be carried out in embodiments in which any number of paths may be selected, the circuit design may include any number of aggressor nets and any number of victim nets.

For the purposes of this disclosure, a “victim window” is all or a portion of a netlist that has undergone a timing analysis. In some embodiments, the timing analysis may include a simulation of the victim window in order to determine timing requirements for the victim window. Such simulation may include an analysis of coupled noise effects associated with the victim window. For the purposes of this disclosure, a “coupled noise effect” is any effect on timing as a result of noise induced by a first net in a second net. The noise may be caused, for example, by coupling capacitance between the first and second nets. For the purposes of this disclosure, the first net (e.g., the net inducing the noise) may be termed the “aggressor net,” while the second net (e.g., the net having noise induced upon it) may be termed the “victim net.” A coupled noise effect between an aggressor net and a victim net may result in downstream timing effects. For example, if the coupled noise effect is sufficient to disrupt the timing of the victim net, the resulting delays may propagate timing changes downstream.

The timing window manipulation module (126) may also manipulate one or more timing window(s) to reduce noise by determining an aggressor net coupled to a victim net along the path. In some embodiments, determining the aggressor net and the victim net may be based at least on the timing violation identifier received by the timing window manipulation module (126). In some embodiments, an aggressor net identifier may be stored in RAM (168) as one or more data elements and/or data structures as aggressor net data (205). A victim net identifier may also be stored in RAM (168) as one or more data elements and/or data structures as victim net data (206). Identifier(s) may include, for example, node identifiers associated with the aggressor net and/or the victim net, net descriptions of the relevant net, etc.

The timing window manipulation module (126) may also manipulate one or more timing window(s) to reduce noise by determining a propagation path through the aggressor net. Such a path may be determined in a variety of ways. For example, a path may be identified (in a reverse manner) beginning at the node of the circuit representing the aggressor net and moving toward a point in the original path in which the aggressor net ceases to have an effect on the victim net, or to a point in the original path in which timing delays induced in the victim window cease.

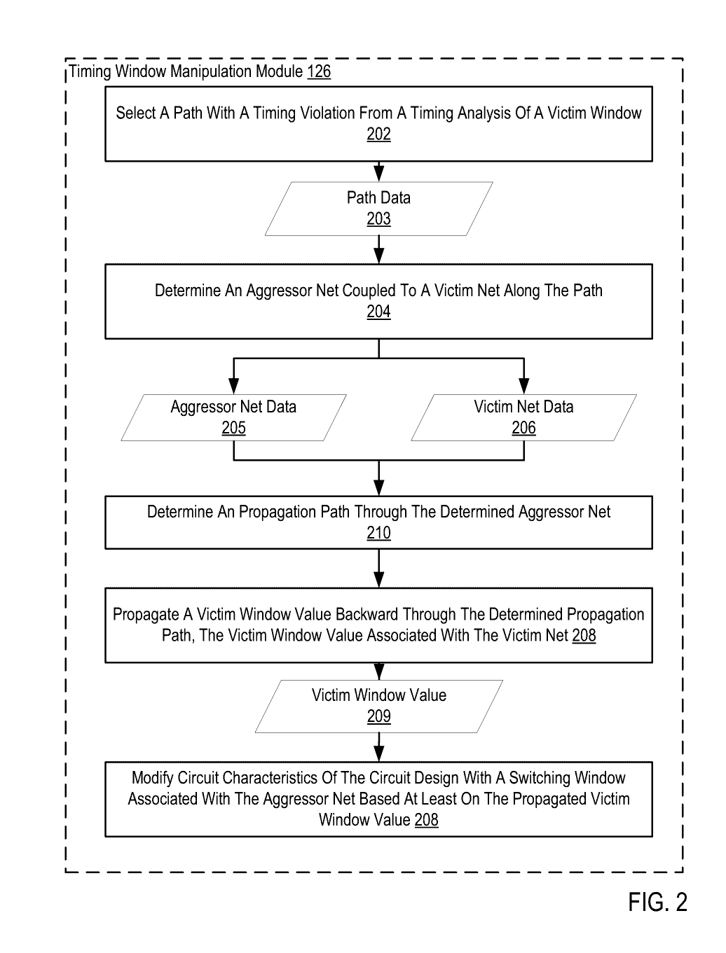

The timing window manipulation module (126) may also manipulate one or more timing window(s) to reduce noise by propagating a victim window value backward through the determined propagation path, where the victim window value is associated with the victim net. As described in more detail below with reference to FIGS. 2-4, for the purposes of this disclosure a “victim window value” is one or more data values associated with a switching window for the victim net. The switching window for the victim net may be referred to as the “victim window” or the “victim sensitivity window.” In some embodiments, each propagated victim window value may be assigned a “weight” to indicate the relative importance of fixing the noise violation represented by that window. This weight may guide an optimization tool in prioritizing which violations are more important to resolve.

In some embodiments, multiple victim windows to be merged together in the backwards propagation to create a composite window. This technique is pessimistic. To resolve that pessimism, each victim window can be independently propagated backwards through the aggressor network. This is defined as “subwindowing.” The subwindowing technique may lead to a large number of windows being propagated. To alleviate this, if multiple subwindows overlap with each other (to some tolerance defined by the user), these subwindows can be merged together. The merged subwindow's weight may be increased to reflect the importance of this newly merged subwindow.

As described in more detail below with reference to FIGS. 2-4, the victim window value may be determined (e.g., calculated, derived, etc.) from one or more statistical timing value(s) associated with the victim net. For example, the victim window value may include an arrival time level value associated with the victim net. In some embodiments, the victim window value may be stored in RAM (168) as one or more data elements and/or data structures as the victim window value (209). In some embodiments, the victim window value (209) may include one or more value(s) that may be propagated backward through the victim window, as described in more detail below with reference to FIGS. 2-4.

The timing window manipulation module (126) may also manipulate one or more timing window(s) to reduce noise by modifying circuit characteristics of the circuit design within a switching window associated with the aggressor net based at least on the propagated victim window value. As described in more detail below with reference to FIGS. 2-4, modifying circuit characteristics of the circuit design within the switching window may include powering down a circuit, powering up a circuit, changing a wiring path, changing a circuit placement, or changing a circuit voltage level. Readers of skill in the art will recognize that such changes are specified in data related to a design of the circuit rather than changes carried out to a physical circuit itself When the design of the circuit is implemented, the changes made by the window manipulation module (126) in the circuit design will be effected in the physically implemented circuit.

Also stored in RAM (168) is an operating system (154). Operating systems useful for manipulating a timing window for noise reduction according to embodiments described herein include UNIX™, Linux™, Microsoft XP™, AIX™, IBM's i5/OS™, and others as will occur to those of skill in the art. The operating system (154), and module (126) in the example of FIG. 1 are shown in RAM (168), but many components of such software typically are stored in non-volatile memory also, such as, for example, on a disk drive (170).

The computer (152) of FIG. 1 also includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for generating a contributor-based power abstract for a device according to embodiments described herein include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (109), which is an example of an I/O adapter specially designed for graphic output to a display device (180) such as a display screen or computer monitor. Video adapter (109) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for generating a contributor-based power abstract for a device according to embodiments described herein include modems for wired dial-up communications, Ethernet (IEEE 802.3) adapters for wired data communications, and 802.11 adapters for wireless data communications.

Example computer (152) may implement certain instructions stored on RAM (168) for execution by processor (156) for timing window manipulation for noise reduction. In some embodiments, the timing window manipulation may be implemented as part of a larger set of executable instructions. For example, timing window manipulation module (126) may be part of an automated timing analysis tool operable to test the timing characteristic of a particular circuit design. Optimization of the timing characteristics may be part of the timing analysis.

One of the goals of an optimization may include achieving timing closure that includes coupled noise effects without unnecessarily increasing power. Certain known techniques for accounting for coupled noise effects assume an infinite switching window for the aggressor net. In order to accommodate a victim net therefore, either the victim net must be sped up (thus consuming additional power) and/or the coupled nets must be separated.

Certain other known techniques for accounting for coupled noise effects only optimize locally, ignoring any propagated coupled noise effects. For example, a timing violation may be identified and aggressor and victim windows identified. However, the victim window may still be powered up in order to overcome this local timing violation. Such an approach, however, ignores any effects of the increased power on timing downstream in the victim window. These limitations may be overcome by manipulating timing windows for noise reduction in accordance with certain embodiments of the present disclosure, as described in more detail below with reference to FIGS. 2-4.

For further explanation, FIG. 2 sets forth a flow chart illustrating an exemplary method for timing window manipulation for noise reduction according to certain embodiments of the present disclosure. The exemplary method illustrated in FIG. 2 may, in some embodiments, be carried out by timing window manipulation module (126).

The example method illustrated in FIG. 2 includes selecting (202) a path with a timing violation from a timing analysis of a victim window. As described in more detail above with reference to FIG. 1, selecting (202) the path may be carried out in various ways, including receiving one or more data element(s) and/or data structure(s) stored in RAM (168) as path data (203). Path data (203) may include a plurality of relevant timing information associated with a victim window.

The example method illustrated in FIG. 2 also includes determining (204) an aggressor net coupled to a victim net along the path. As described in more detail above with reference to FIG. 1, determining (204) the aggressor net coupled to the victim net may be carried out in various ways, including identifying one or more aggressor net(s) and storing associated data elements and/or data structures in RAM (168) as aggressor net data (205). Determining (204) may also include identifying one or more victim net(s) and storing associated data elements and/or data structures in RAM (168) as victim net data (206).

The example method illustrated in FIG. 2 also includes determining (210) a propagation path through the determined aggressor net. As described in more detail above with reference to FIG. 1, determining (210) such a propagation path may be carried out in various ways, including by identifying a path from the aggressor net to a point in the path in which timing delays in the victim net cease or in which induced noise from the aggressor net no longer affects the victim net.

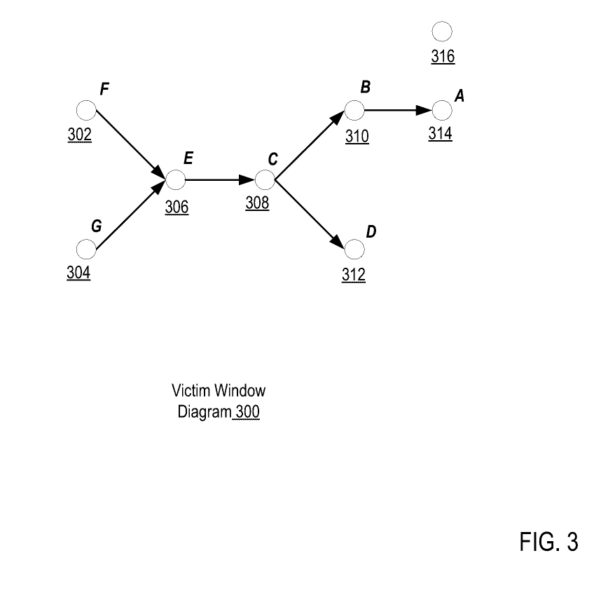

The example method illustrated in FIG. 2 also includes propagating (208) a victim window value backward through the determined propagation path, where the victim window value is associated with the victim net. In some embodiments, the victim window value may be based at least on one or more statistical timing value(s). For example, an arrival time level value for the victim net may be used to generate a victim window value for the victim net, as described in more detail below with reference to FIG. 3. In some embodiments, the victim window value may be stored in RAM (168) as the victim window value (209).

Propagating (208) the victim window value backward through the determined propagation path may be carried out by the timing window manipulation module (126) propagating the victim window value backward to prior nodes in the victim window. At a prior node, additional analyses may take place. For example, if a node includes multiple successor paths (with each path propagating a victim window value to that node), the timing window manipulation module (126) may perform a statistical comparison of victim window values propagated backward from the various successor nodes (e.g., a maximum of the incoming victim window information). The propagation methods are similar to those in use for certain current timing analysis tools in backward-propagating other values such as required arrival time level values. Such methods will occur to one of ordinary skill in the art.

In some embodiments, propagating (208) the victim window value backward through the determined propagation path may include propagating, with the victim window value, additional information describing a victim net's noise calculation. Such additional information may also include delay change due to a victim's noise event, slew change due to a victim's noise event, or slack change due to a victim's noise event.

The example method illustrated in FIG. 2 also includes modifying (208) circuit characteristics of the circuit design within a switching window associated with the aggressor net based at least on the propagated victim window value. Modifying (208) circuit characteristics of the circuit design within the switching window may be carried out in a variety of ways including powering down a circuit, powering up a circuit, changing a wiring path, changing a circuit placement, and/or changing a circuit voltage level.

In embodiments in which the timing window manipulation module (126) optimizes (208) the switching window, the timing window manipulation module (126) may make optimization decisions relative to the victim window and/or the switching window. For example, by powering down a circuit associated with the aggressor net, the timing window manipulation module (126) may slow the switching window and avoid timing violations. By modifying circuit characteristics of the circuit design within the scheduling window (in lieu of and/or in addition to optimizing the victim window), the timing window manipulation module (126) may reduce overall power consumption while taking into account downstream timing effects.

For further explanation, FIG. 3 illustrates an example victim window diagram (300) for manipulating timing windows for noise reduction, in accordance with certain embodiments of the present disclosure. In some embodiments, the example victim window diagram (300) includes a plurality of nodes (302, 304, 306, 308, 310, 312, 314, 316). Each node may represent an electrical component and/or combination of electrical components of an electronic device design undergoing a timing analysis.

The example victim window diagram (300) includes an aggressor net and a victim net. The aggressor net in the example victim window diagram (300) is illustrated at node (314). In some embodiments, the node (314) representing the aggressor net may have a coupled noise effect with the victim net, which is illustrated at node (316). The node (316) representing the victim net may be part of a larger path (not shown) within victim window diagram (300).

The example victim window diagram (300) also includes a plurality of predecessor nodes (302, 304, 306, 308, 310, 312) that precede the node (314) representing the aggressor net. Each node is connected to at least one other node via an edge. The nodes (302, 304, 306, 308, 310, 312, 314) constituting the aggressor net path are labeled as A-G, respectively, to aid in understanding. One of ordinary skill in the art would understand that more, fewer, and/or different configurations of nodes within a path would be possible without departing from the scope of the present disclosure.

As described in more detail above with reference to FIGS. 1-2, the node (316) representing the victim net may have an associated victim window value. The victim window value may be based at least on one or more statistical timing values. For example, the initial victim window value may be set to be equal to an arrival time level value. The arrival time (“AT”) level at a particular node is a modeling characteristic for that particular node representing a scheduling order to accurately compute a time at which a signal will arrive at that node based on a timing model as a whole. The following example values use the AT level in order to aid in understanding. One of ordinary skill in the art would understand that different values (or types of values) may be used without departing from the scope of the present disclosure.

Following the example described above, assume that the node (316) representing the victim net has a negative “slack,” or a difference between constraints on one node from various other nodes. For example, a timing slack may indicate a difference in the timing associated with a plurality of nodes incoming at a target node. Negative slack, therefore may be indicative of a timing violation.

Additionally, for this example, assume that the node (316) representing the victim net has a timing value often. The victim window (“VW”) of the node (314) representing the aggressor net, node “A,” may then be given the value of the AT level value of the node (316) representing the victim net. This value, the victim window value of node A, may be denoted as “VW(A).” In this example, VW(A)=10.

Continuing the example, the timing window manipulation module (126) may determine (210) a propagation path through the aggressor net and propagate (208) the victim window value backward through the determined propagation path. This may be done, for example, by taking into account a delay from one node to another. Thus, the victim window value propagated (208) backward to node B (310) from node A (314) may take into account the delay from node A (314) to node B (310). Assuming this delay to be a value of one, then the victim window value at node B, VW(B), may be one less than the victim window value of node A. In this example, VW(B)=VW(A)−1=10−1=9.

Continuing the example, assume that the victim window value propagated to node D (e.g., node D is a second aggressor net, node D has a propagated victim window value from a second aggressor net, etc.) has a value of eleven. Nodes B (310) and D (312) are successor nodes to node C (308). In order to propagate (208) the victim window backward to node C (308), the timing window manipulation module (126) may undertake a statistical comparison of the victim window values of the successor nodes.

In the example illustrated, the statistical timing values are chosen in order to determine the time at which a signal incoming to node A must be later than in order to ensure that the signal falls outside the victim net's sensitivity window. Thus, in order to propagate (208) the victim window value backward to node C (308), the timing window manipulation module (126) may take a maximum of the delayed victim window values of all successor nodes. Thus the victim window value at node C, VW(C)=MAX(VW(B)−1, VW(D)−1)=MAX(9−1, 11−1)=MAX(8, 10)=10. The timing window manipulation module (126) may then propagate VW(C) back to node E. Accounting for the delay, the propagated victim window value at node E, VW(E)=VW(C)−1=10−1=9. Continuing the example, the timing window manipulation module (126) then propagates the victim window value back to nodes F, G (302, 304). The victim window value at node F, VW(F)=VW(E)−1=9−1=8. Similarly the victim window value at node G, VW(G)=VW(E)−1=9−1=8.

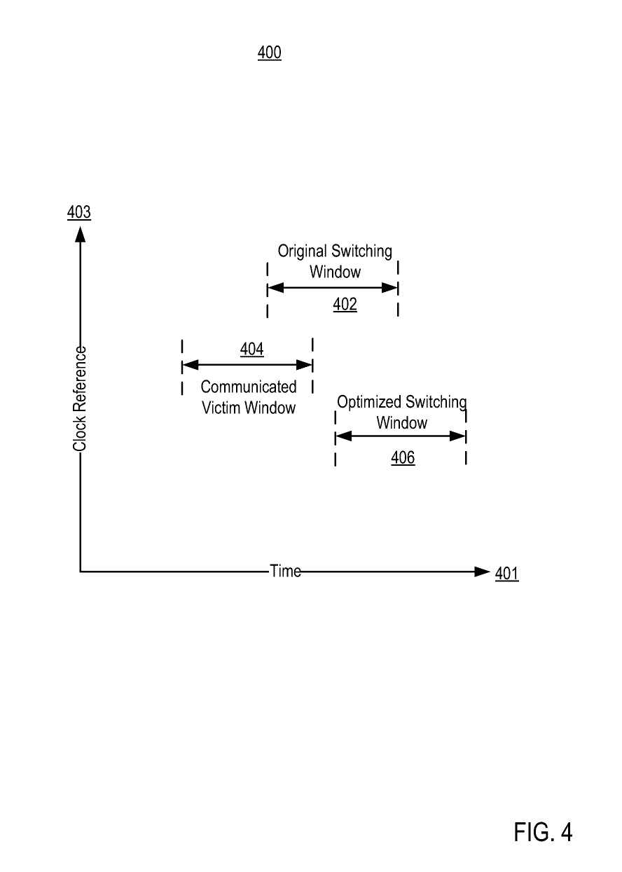

The timing window manipulation module (126) may then use the propagated victim window value to optimize (208) a switching window associated with the aggressor net, as described in more detail above with reference to FIGS. 1-2. For example, as described in more detail below with reference to FIG. 4, the victim window value may be used to alter the scheduling window associated with the aggressor net in order to avoid the victim net sensitivity window. The timing window manipulation module (126) may use the propagated victim window value in creating a scheduling order for a timing analysis. Furthermore, aforementioned design changes could be made within optimization flows including late mode timing correction, early mode padding, electrical correction, and combinations thereof.

In some embodiments, a designer of the modeled electronic device may also use propagated victim window value to alter the component(s) underlying the aggressor net. For example, one or more component(s) may be powered down (e.g., slowed) and/or powered up (e.g., sped up) in order to avoid the victim net sensitivity window. Additionally, a wiring path, circuit placement, or voltage level may be altered in order to reduce the coupled noise effect in order to reduce an impact of the coupled noise effect.

By propagating the victim window value backward through the victim window, the timing window manipulation module (126) may make potential noise impacts available to prior portions of the victim window in order to aid in design decisions. Additionally, a designer may take into consideration any propagated effects. These effects may then be addressed as part of the overall timing analysis.

FIG. 4 illustrates an example timing graph (400) illustrating a result of modifying (208) circuit characteristics of the circuit design within a switching window associated with the aggressor net, in accordance with certain embodiments of the present disclosure. In some embodiments, example timing graph (400) includes a horizontal axis (401) representing the passage of time as well as a vertical axis (403) representing a clock reference.

Example timing graph (400) includes original switching window (402). Original switching window (402) may be associated with a non-optimized aggressor net. Example timing graph (400) also includes propagated victim window value (404). As illustrated in example timing graph (400), there is an overlap between original switching window (402) and propagated victim window value (404). This overlap may result in a coupled noise effect and thus a timing violation, as described in more detail above with reference to FIGS. 1-3.

As described in more detail above with reference to FIGS. 1-3, modifying (208) circuit characteristics of the circuit design within may result in the scheduling window associated with the aggressor net may be slowed in order to avoid the victim net sensitivity window. This is illustrated in example timing graph (400) by optimized switching window (406). Optimized switching window (406) no longer overlaps propagated victim window value (404). Thus, the coupled noise effect may be relatively reduced and potential timing violations avoided.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments without departing from its true spirit. The descriptions in this specification are for purposes of illustration only and are not to be construed in a limiting sense. The scope of the present disclosure is limited only by the language of the following claims.

1-10. (canceled)

11. An apparatus for timing window manipulation for noise reduction in a circuit design, the apparatus comprising a computer processor and a computer memory operatively coupled to the computer processor, the computer memory having disposed within it computer program instructions capable of:
selecting a path of a circuit design having a timing violation from a timing analysis of a victim window;
determining an aggressor net coupled to a victim net along the path;
determining a propagation path through the determined aggressor net;
propagating a victim window value backward through the propagation path, the victim window value associated with the victim net; and
modifying circuit characteristics of the circuit design within a switching window associated with the aggressor net based at least on the propagated victim window value.

12. The apparatus of claim 11, wherein the timing analysis comprises an analysis of a coupled noise effect associated with the victim window.

13. The apparatus of claim 11, wherein modifying circuit characteristics of the circuit design with the switching window comprises an action selected from the group consisting of: powering down a circuit, powering up a circuit, changing a wiring path, changing a circuit placement, changing a circuit voltage level, or changing a circuit topology.

14. The apparatus of claim 11, wherein the victim window value is based at least on a statistical timing value.

15. The apparatus of claim 14, wherein the statistical timing value comprises an arrival time level value.

16. The apparatus of claim 11, wherein modifying circuit characteristics of the circuit design within the switching window is performed during an optimization process selected from the group consisting of: a late mode timing closure, an early mode timing closure, or a false switching reduction.

17. A computer program product for timing window manipulation for noise reduction in a circuit design, the computer program product disposed upon a computer readable medium, the computer program product comprising computer program instructions capable, when executed, of causing a computer to carry out the steps of:
selecting a path of a circuit design having a timing violation from a timing analysis of a victim window;
determining an aggressor net coupled to a victim net along the path;
determining a propagation path through the determined aggressor net;
propagating a victim window value backward through the propagation path, the victim window value associated with the victim net; and
modifying circuit characteristics of the circuit design within a switching window associated with the aggressor net based at least on the propagated victim window value.

18. The computer program product of claim 17, wherein the timing analysis comprises an analysis of a coupled noise effect associated with the victim window.

19. The computer program product of claim 17, wherein modifying circuit characteristics of the circuit design with the switching window comprises an action selected from the group consisting of: powering down a circuit, powering up a circuit, changing a wiring path, changing a circuit placement, changing a circuit voltage level, or changing a circuit topology.

20. The computer program product of claim 17, wherein the victim window value is based at least on a statistical timing value.
